(19) United States
(12) Patent Application Publication
(10) Pub. No.: US 2014/0127933 A1
(43) Pub. Date: May 8, 2014

(54) Plug-In Connector Having Contacts

(71) Applicants: Thomas Franke, Weisweil (DE); Fritz Zügel, Waldkirch (DE); Sven Rissler, Elzach (DE); Achim Hoch, Waldkirch (DE)

(72) Inventors: Thomas Franke, Weisweil (DE); Fritz Zügel, Waldkirch (DE); Sven Rissler, Elzach (DE); Achim Hoch, Waldkirch (DE)

(73) Assignee: Hummel AG, Denzlingen (DE)

(21) Appl. No.: 14/005,623

(22) PCT Filed: Feb. 17, 2012
(86) PCT No.: PCT/EP12/00723

§ 371 Date: Dec. 19, 2013

(30) Foreign Application Priority Data
Mar. 17, 2011 (DE) 20 2011 004 089.5

(51) Int. Cl. H01R 13/623

(52) U.S. Cl. CPC H01R 13/623
USPC 439/372

(57) ABSTRACT

The invention relates to a plug-in connector (1) having a receiving sleeve (2) which encloses an insulation for the contacts (4), and a plug-in portion (3) which can be assembled with said sleeve and which also encloses an insulation (5) for counter contacts (6), wherein said plug-in connector can be coupled and attached in the inserted position without requiring a threading having a counter threading or having a counter nut. For this purpose, the outer side of the plug-in portion (3) and the inner side of the receiving sleeve (2) each have a non-round cross section in some regions on a rotating sleeve (7) which is rotatable relative to the receiving sleeve (2). Said non-round cross sections of the plug regions that can be inserted into one another fit together in a form-fit manner in the peripheral direction, and thus enable assembly in the position of use thereof. In the position of use, said regions are axially offset with respect to each other, so that the non-round region of one portion engages axially behind the other portion, if the rotating sleeve is twisted into the locked position thereof.

### CROSS-REFERENCE TO RELATED APPLICATIONS

This application claims priority from PCT/EP2012/000723 filed on Feb. 17, 2012, and DE 20 2011 004 089.5 filed on Mar. 17, 2011, both of which are hereby incorporated by reference in their entireties.

### BACKGROUND OF THE INVENTION

1. Field of the Invention

The invention relates to a plug-in connector having a receiving sleeve containing axially parallel contacts and having a plug or plug-in part containing insulation for the axially parallel counter contacts that can be plugged together, so that the receiving sleeve and the plug-in part are arranged one inside the other in the axial direction in some areas in the use position and are secured to prevent axial releasing movement.

2. State of the Art

Various embodiments of plug-in connectors are known. For mutual connection, there are known union nuts, which prevent an unintentional releasing movement after being screwed on, but they require an appropriate thread. Furthermore, an increased assembly effort is required to attach and activate the union nuts.

### SUMMARY OF THE INVENTION

Therefore, an object of the invention is to provide a plug-in connector of the type previously defined, wherein a connection of the intermatable parts and securing them against unintentional axial releasing movements is permitted without requiring union nuts.

To achieve this object, a plug-in connector as previously defined is characterized in that it has an outside of the plug-in part and an inside of the receiving sleeve having non-round cross sections or peripheries in some portions, so that the non-round cross portions fit together with one inside the other in a form-fitting manner and are offset axially with respect to one another in the use position. On the receiving sleeve, the non-round portion (region) is provided on the inside of a rotating sleeve that can be twisted in relation to the receiving sleeve. On the plug part, an undercut or a groove running along at least a portion of the circumference (e.g., a peripheral ring groove) is provided in the axial or plug-in direction behind the non-round region. In a coupling position, the rotating part of the receiving sleeve extends with its non-round inside cross-section in a form-fitting manner into the region of the undercut, groove or ring groove. By relative rotation, the regions having a non-round cross section can be adjusted out of their position.

The non-round region of the plug-in part may thus be inserted so deeply into the receiving sleeve in the axial direction in relation to the non-round region of the receiving sleeve so that the two non-round regions are offset axially relative to each other. During this displacement movement, they fit inside one another in a form-fitting manner and may be plugged into one another and displaced axially in relation to one another and then twisted in relation to one another, so that they thereby engage behind one another and thus prevent any axial releasing movement unless they are twisted back.

An advantageous embodiment of the invention may thus provide that the non-round region of the plug-in part is displaceable axially in relation to the non-round region of the receiving sleeve from the form-fitting arrangement, to such an extent that the non-round region of the plug-in part is situated adjacent to the non-round region of the receiving sleeve in the axial direction and is thus outside of the region of the receiving sleeve but inside the area of the undercut, thereby enabling a relative rotation of the two non-round regions into their undercutting positions. After the displacement movement, the twist in the two non-round regions relative to one another is sufficient to secure the form-fitting coupling of the two parts in relation to one another in the axial direction, wherein the rotary part of the receiving sleeve and the plug-in part, for example, experience this mutual relative movement.

It may be advantageous for good releasability from the coupling position if the rotary part of the receiving sleeve can be rotated against a restoring force into the open position and can be releasably secured in this position. If this secured position is released, the arrangement as a whole enters the coupling position or closed position, i.e., the rotary part of the receiving sleeve is then automatically rotated back into the closed position contrary to the opening direction so that the plug-in part is secured in the receiving sleeve.

A spring that is or can be put under tension in rotating the rotary part, or a helical spring that is curved to conform to the circumference and runs along a portion of the circumference may be provided between the rotary part of the receiving sleeve and this receiving sleeve itself. A helical spring in particular is an inexpensive component and has the advantage over a torsion spring, which may also be used. The inside and/or outside diameter of these springs themselves are not altered when they are activated.

An especially advantageous embodiment of the invention may provide that the non-round cross-sectional shape of the non-round region of the receiving sleeve and that of the non-round region of the plug-in part are formed by at least one flattened area of an originally circular circumference of the coupling regions. In particular, they may be formed by two or three flattened areas that are offset in relation to one another in the circumferential direction, such that the plug-in part and the receiving sleeve can be plugged together in the axial direction when the flattened area(s) of the one part are arranged coaxially with the flattened areas of regions that are adjacent in the circumferential direction. The flattened areas are thus shaped and arranged so that when plugged together the flattened areas of the one part can be displaced along the non-flattened regions of the other part, after which the non-flattened regions of both parts then come to lie one behind the other in the axial direction due to the relative rotation, which serves the purpose of coupling.

Thus the parts of the non-round region of the receiving sleeve that protrude with respect to the flattened area(s) and the parts of the plug-in part in coupling position in the axial direction advantageously engage behind one another, wherein the use position of the plug-in connector is defined without using a union nut or a similar additional part.

The outside dimensions of the plug-in part may be larger in the non-flattened region than the inside dimensions of the non-flattened region of the receiving sleeve, and the dimensions may be selected so that each of the flattened regions can be advanced past one another in the axial direction on the non-flattened regions. For the form-fitting connection of the plug-in part to the receiving sleeve, these two parts are thus arranged in relation to one another so that the flattened regions come to lie in a coaxial position with the protruding non-flattened regions, after which the parts can be displaced axially into their coupling positions with no problem. Once this plug-in movement has been performed, the relative rotation can then take place, by means of which the non-flattened regions come to lie one behind the other in the axial direction, whereby a form-fitting connection against the plug-in direction is established.

The axial extent or dimension of the non-round region of the rotary sleeve or rotary part of the receiving sleeve may be the same as or smaller than the axial width of the undercut or groove or ring groove on the plug-in part. This achieves the result that with a relative rotation, this undercut or the like can receive the non-round region of a larger radial dimension of the rotary part and can be brought behind the non-round region of a larger radial dimension of the plug-in part.

The rotation of the rotary part of the receiving sleeve may be limited by an interior stop, and the stop may block a relative rotation beyond the coupling position. Thus the coupling movement is simplified for the user because the user need only rotate until the stop itself prevents further rotation. Then the coupling position has been reached.

It is desirable for the turning distance of the rotary sleeve or of the rotary part to correspond to approximately one-half the circumferential distance between two adjacent flattened areas on the plug-in part along its circumference. A large circumferential portion of the non-flattened regions one behind the other in an axial direction is thereby achieved.

A protrusion or locking cam which engages in a counter opening in the rotary part in the coupling position in the radial direction and is adjustable or is particularly pushed radially inward for releasing may be provided for fixation of the coupling position of the rotary part. It is also or additionally possible for the rotary part to have a groove or a recess in which the protrusion or locking cam engages in the open position for fixation. The open position of the rotary part can thus be secured releasably in a defined position in relation to the receiving sleeve, which can facilitate the plugging or coupling operation.

It is advantageous if the protrusion or the locking cam engages in the counter opening of the rotary part for securing the coupling position of the rotary part against a restoring force or a spring force and for releasing the locked position against this restoring force out of the counter opening, is particularly radially inwardly adjustable or movable. The user need only depress this protrusion or locking cam against this restoring force to release the relative rotational movement between the rotary part and the receiving sleeve in order to thereafter be able to perform the desired rotational movement—whether into the closed position or into the open position.

It should be noted that instead of the rotation of the rotary sleeve and/or of the rotary part, the plug-in sleeve itself could be rotated with respect to the secured rotary part because these two parts are capable of rotating in relation to one another. However, since the rotary part has a lower mass and is smaller than the remaining plug-in sleeve, it is expedient to twist the rotary part with respect to the plug-in sleeve in performing the coupling movement.

It is advantageous if the transition from the larger radial dimension to the smaller dimension or the flattened area is designed to be steady, continuous or particularly rounded in the case of the non-round circumferential areas. The largest radial dimension may thus develop steadily into the smaller radial dimension in at least some areas and then back again to prevent sharply protruding radial protrusions with a corresponding risk of breakage, despite the non-round cross section. Larger regions of the circumferences may accordingly engage behind one another entirely or partially in the coupling position.

Another advantageous embodiment of the invention of considerable importance exists in that the plug-in part has an outside thread in its non-round region, the thread being entirely or partially flattened or removed or sanded down or ground off in the region(s) of smaller outside dimensions or flattened areas. It is thereby possible to also use this plug-in part in another form or for other purposes in which it can be screwed into a counter piece or provided with a union nut.

A combination of one or more of the features and measures described above, results in a plug-in connector for electric contacts in which an axial plug-in movement of a plug-in part into a receiving sleeve is possible, this plug-in part being secured in its coupling position by the rotation of a rotatable sleeve or the rotary part of the receiving sleeve so no union nut or screw connection is necessary on flanges or the like, but nevertheless wherein a form-fitting connection contrary to the releasing direction of this plug-in connector is achieved.

Exemplary embodiments of the present invention are described in greater detail below with reference to the drawings which are partially schematic diagrams.

### BRIEF DESCRIPTION OF THE DRAWINGS

FIG. 1 shows a diagram of a plug-in connector according to the invention in the open or released position before assembly, wherein a receiving sleeve containing axial parallel counter contacts with insulation and a plug-in part which can be assembled with it and containing insulation for axial parallel counter contacts. The outside of the plug-in part as well as the inside of the plug area of the receiving sleeve, which cooperates in the use position have a non-round cross section or circumference, fitting together with one inside the other in a form-fitting manner and being offset in relation to one another in the use position and engaging one behind the other. The non-round region of the plug-in part has an outside thread.

FIG. 2 shows a diagram similar to FIG. 1, in which the plug-in part is without a thread in its non-round coupling or plug-in region, wherein the contact having insulation is not shown.

FIG. 3 shows a side view of the plug-in connector according to FIG. 2 during the insertion of the plug-in part into the coupling region of the receiving sleeve but before being secured in this position in a form-fitting manner.

FIG. 4 shows a cross section of the coupling regions and/or the non-round regions during the performance of the plug-in movement according to the sectional line A-A in FIG. 3. The non-round regions of the receiving sleeve with larger radial thickness are arranged coaxially with the regions of the plug-in part having a flattened cross section, so that a mutual axial displacement is possible in this position.

FIG. 5 shows a side view corresponding to FIG. 3 with a partial longitudinal section through the coupling region after complete insertion of the plug-in part into the rotary sleeve of the receiving sleeve so that the non-round regions of the plug-in part and the rotary sleeve are offset in relation to one another in the axial direction.

FIG. 6 shows a cross section according to sectional line B-B in FIG. 5, corresponding to FIG. 4, wherein the non-round regions are still in their position rotated in relation to one another and thus fit inside one another in the axial direction.

FIG. 7 shows a diagram corresponding to those in FIGS. 3 and 5 after rotation of the rotary sleeve into a position in which the flattened areas of the two regions that can be plugged into one, and the larger dimensions in cross section are respectively arranged coaxially. The circumferential region of the plug-in part, which is thicker in the radial direction and extends farther inward, is designed to be larger in cross section in the radial direction, so as to engage beneath or behind the region of the rotary sleeve in the axial direction.

FIG. 8 shows a cross section of the coupling position according to the cross-sectional line C-C in FIG. 7, wherein the flattened regions of the two parts have a radial distance between one another and engage behind one another in the axial direction in their dimension larger regions of the non-round cross sections.

FIG. 9 shows a diagram of the receiving part with a part of the rotary sleeve and a helical spring arranged between the rotary sleeve and the receiving part in the circumferential direction in a relaxed position, so that the closed position of the rotary sleeve is predetermined in this coupling position.

FIG. 10 shows a diagram corresponding to that in FIG. 9 after the rotation of the rotary sleeve into its open position with resulting tension or compression of the compression spring, so that after unlocking from the opening position, the closed position occurs automatically or is at least aided by the relaxing compression spring.

### DETAILED DESCRIPTION OF THE PREFERRED EMBODIMENTS

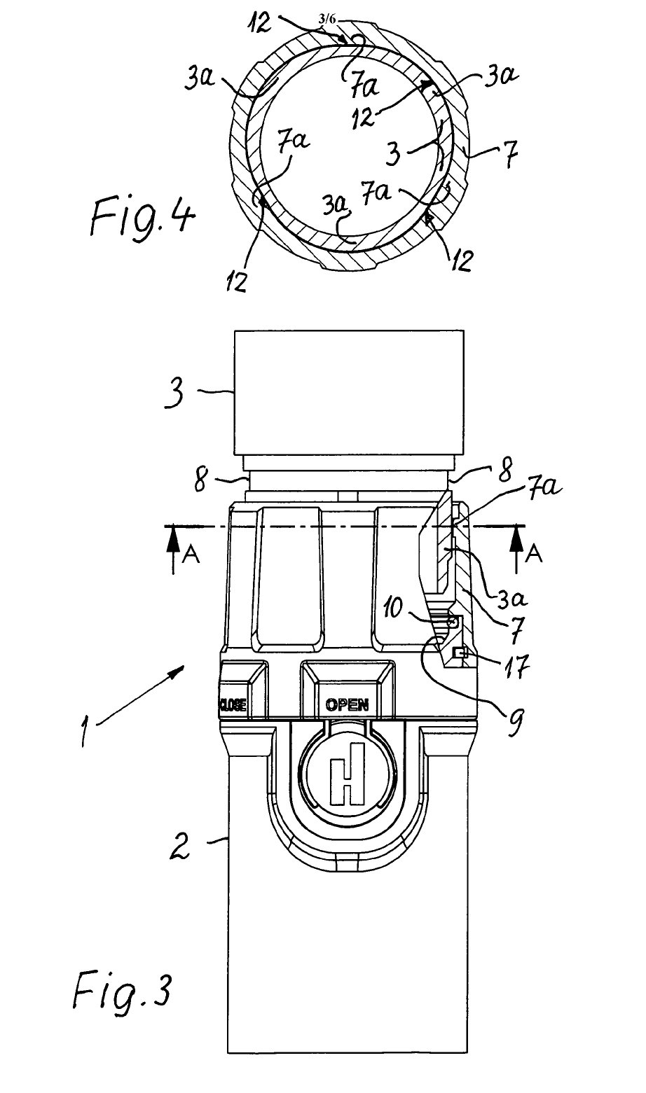

A whole plug-in connector labeled as 1 has a receiving sleeve 2 containing axially parallel contacts 4 and a plug-in part 3 or a plug 3, which can be plugged together with the receiving sleave, and contains insulation 5 for axially parallel counter contacts 6. The receiving sleeve 2 and the plug-in part 3 can be plugged together in the axial direction according to FIGS. 3 through 8 and are arranged so they engage inside one another axially in some regions in the use position and are secured to prevent an axial releasing movement in a manner yet to be described according to FIGS. 7 through 9.

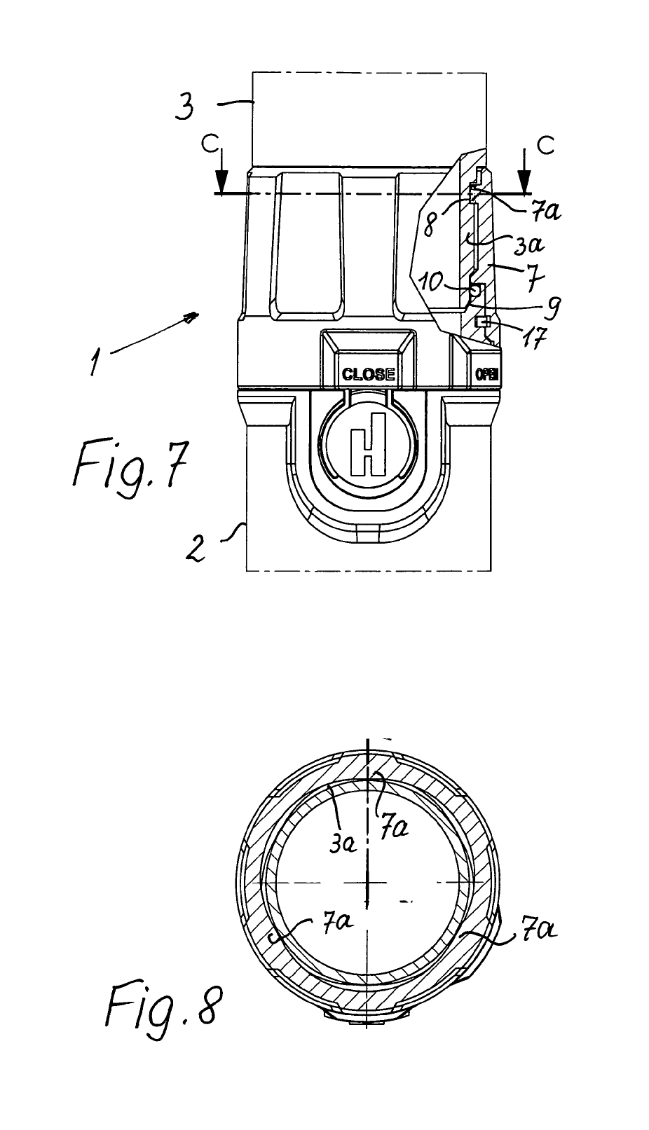

As shown clearly in FIGS. 4, 6 and 8, the outside of the plug-in part 3 and the inside of the receiving sleeve 2 each have a non-round cross section or circumference in some regions, wherein the non-round cross sections according to FIG. 4 fit together and one inside the other in a form-fitting manner in the circumferential direction and are offset axially and in the rotational direction with respect to one another in the use position according to FIG. 8. According to FIG. 4, the non-round outside cross section of the plug-in part 3 and the inside cross section of the receiving sleeve 2 correspond such that they sit together in a form-fitting manner.

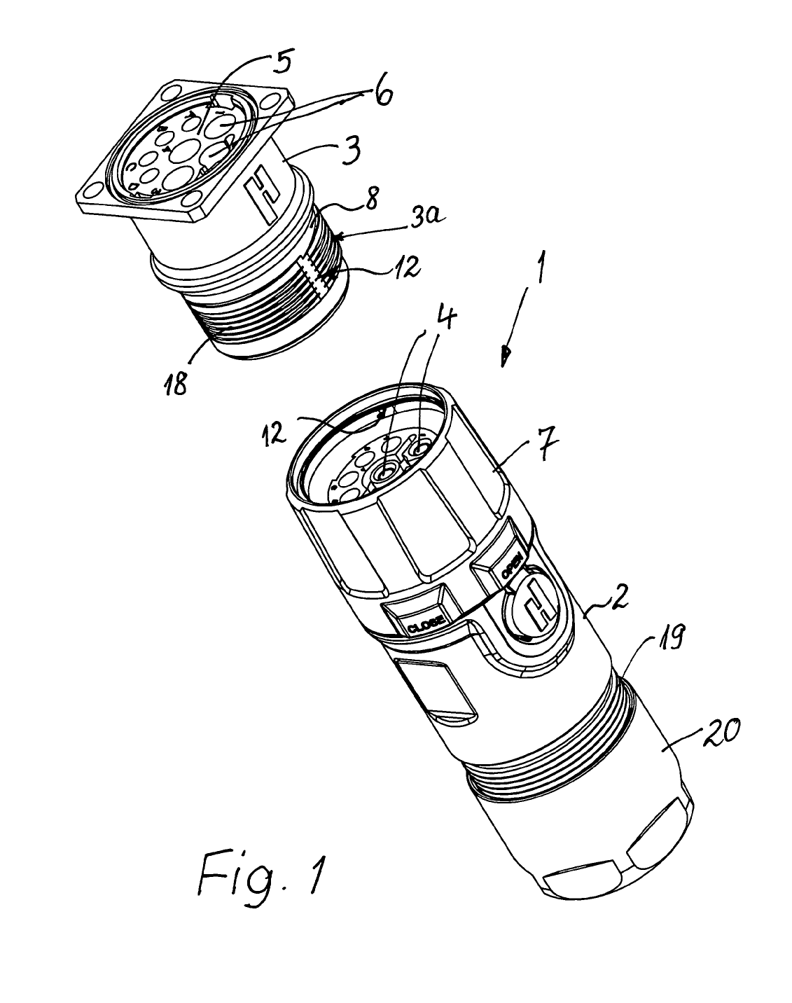

On the receiving sleeve 2, the non-round region is provided on the inside of a rotary sleeve 7, which can be rotated in relation to the receiving sleeve 2. According to FIGS. 1 to 3 as well as FIGS. 4 to 8, an undercut in the form of a ring groove 8 situated on the circumference of the plug-in part 3 is provided on the plug-in part 3 behind (in the axial or plug-in direction) the non-round region 3a, which has a larger radial thickness.

The rotary sleeve 7 forms a rotary part of the receiving sleeve 2 and has non-round internal cross sections 7a of a larger radial thickness. In the coupling position according to FIG. 5—even before completion of the coupling movement—and according to FIG. 7, it extends to the region of the undercut or the ring groove and is of a size such that the ring groove 8 can receive this non-round internal area 7a of a larger radial thickness therein. Thus, regions 3a and 7a having non-round cross sections are adjusted by relative rotation out of the position illustrated in FIG. 5 and into the position illustrated in FIG. 7 from a position which initially fits together in a form-fitting manner in the axial direction (FIG. 4) and can be shifted axially past one another into a self-engaging position. This self-engaging position of the non-round regions 3a and 7a can be seen in FIGS. 7 and 8 which show clearly that in this position the plug-in part 3 can no longer be pulled axially out of the receiving part 2 because its non-round region 3a with its larger radial dimension engages behind or beneath the non-round region or internal cross section 7a of the rotary sleeve 7 in the axial direction. The non-round region 7a and the rotary sleeve 7 are accordingly understood here to refer to their cross section and circumferential area of a larger radial wall thickness and a smaller internal clearance.

Upon comparing FIGS. 3-8, it is clear that the non-round region 3a of the plug-in part 3 can be shifted axially in relation to the non-round region 7a of the receiving sleeve 2 and/or of the rotary sleeve 7, so that the non-round region 3a of the plug-in part 3 according to FIG. 7 is adjacent to the non-round region 7a of the receiving sleeve 2 and/or the rotary sleeve 7 and is in the area of the undercut or ring groove 8, so that the relative rotation of the two non-round regions into their engaging position is enabled. FIG. 5 shows that the plug-in part 3 which is first inserted into the rotary sleeve 7 according to FIG. 3, is inserted so deeply that the ring groove 8 in the axial direction corresponds to the non-round region 7a of the rotary sleeve 7, so that it is then possible to rotate according to FIG. 7 into the coupling position in which the non-round region 7a engages in this ring groove 8 in a form-fitting manner. At the same time, this shows that the axial width of the ring groove 8 corresponds to that of the non-round region 7a, so that a good mutual fixation is possible.

At the same time, the plug-in part 3 is sealed in the axial direction in contact with a stop 9 of the receiving sleeve 2 and is sealed on its outside with the help of a sealing ring, namely an O-ring 10 in the exemplary embodiment.

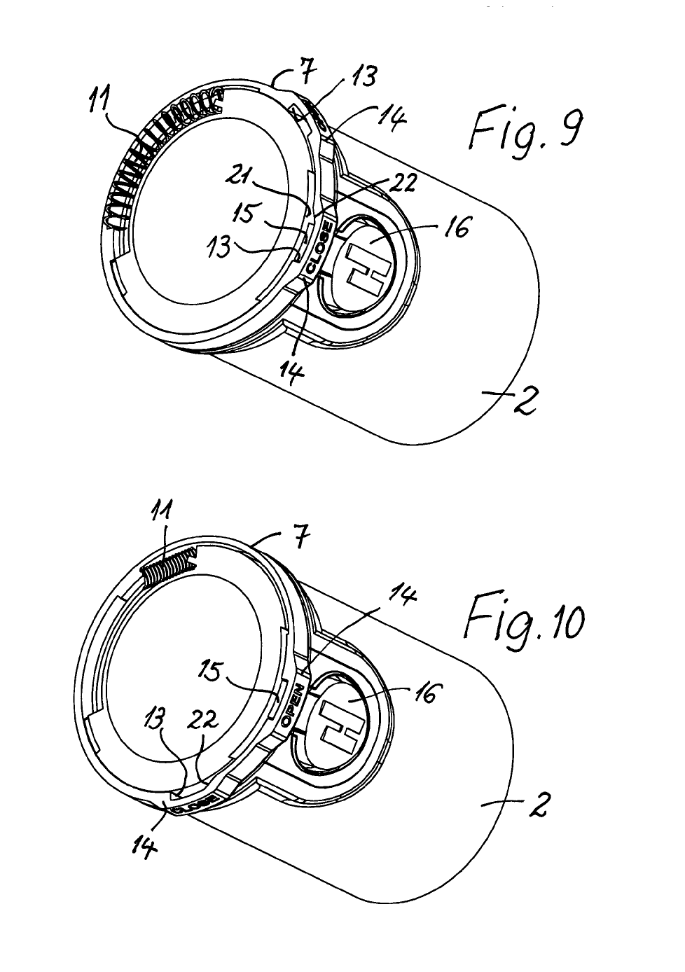

The rotary part of the receiving sleeve 2, which is referred to above as a rotary sleeve 7, is rotatable into the open position against a restoring force according to FIGS. 9 and 10 and is releasably secured in this position, so that the locking operation takes place or is supported automatically due to the restoring force after this fixation has been released. However, the opposite arrangement may optionally also be possible such that the rotary sleeve 7 is rotatable against the restoring force into the coupling position or the closed position and is releasably secured in this position, so that after being released, the opening or reverse turning of the rotary sleeve 7 takes place or is automatically aided.

The illustrated embodiment has the advantage that due to the restoring force, the coupling position cannot be opened inadvertently by an unintentional releasing movement.

It can be seen in FIGS. 9 and 10 that a spring 11 is provided. The spring is a helical spring which is under tension and runs along a portion of a circumferential rotary ring which is partially visible due to the sectional diagram and which is provided between the rotary sleeve 7 of the receiving sleeve 2 and the receiving sleeve 2. The spring is under tension even with the turning of the rotary sleeve from the relaxed closed coupling position seen in FIG. 9 to the compressed opened coupling position shown in FIG. 10.

The releasable fixation of the rotary sleeve 7 in relation to the receiving sleeve 2 is explained in greater detail below.

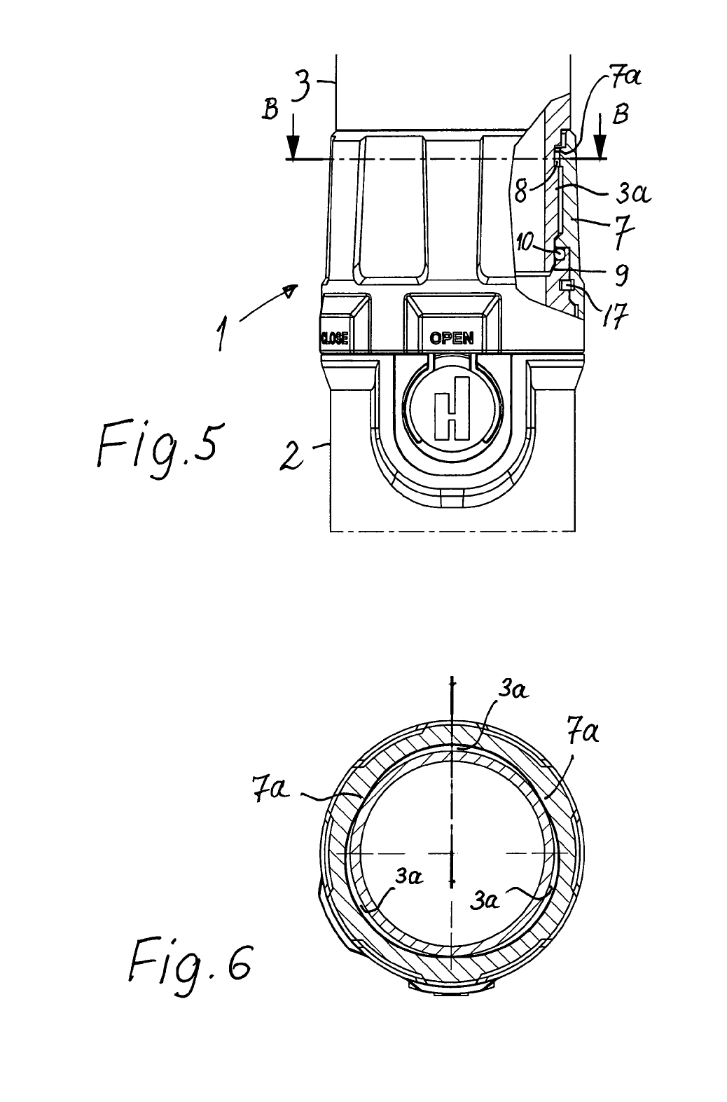

The non-round cross-sectional shape of the non-round region 7a of the receiving sleeve 2 and/or the rotary sleeve 7 which is arranged on the receiving sleeve 2 and belongs to it, and the cross-sectional shape of the non-round region 3a of the plug-in part 3, correspond in the manner already mentioned above. As a result, they can be inserted one into the other. The non-round region defines at least one flattened area 12, and in the exemplary embodiment three such flattened areas 12 that are offset with respect to one another are provided in the circumferential direction and are evenly distributed. Thus, the plug-in part 3 and the receiving sleeve 2 can be plugged together in the axial direction on the rotary sleeve 7 as shown in FIGS. 3 and 4 as well as FIGS. 5 and 6 with the flattened region(s) or flattened areas 12 of the one part arranged coaxially and adjacent to the regions of flattened areas 12 of the other part. This is especially clear in FIG. 4, where the flattened areas 12 of the plug-in part 3 are arranged at locations inside the rotary sleeve 7 having a smaller inside cross section, as compared to the relative mutual rotation shown in FIG. 8.

FIG. 6 shows the two non-round regions in their position in which they are assembled but not yet in the coupling position.

Due to the overall arrangement of the axial extent and the dimension of the non-round regions 3a and 7a as well as the flattened areas 12, the parts of the non-round regions 7a of the receiving sleeve 2 and/or the rotary sleeve 7 protrude with respect to the flattened area(s) 12 as well as the non-round regions 3a of the plug-in part 3 in the coupling position in the axial direction engage behind one another, i.e., after performing the turning of the rotary sleeve 7, as illustrated in FIGS. 7 and 8.

When FIGS. 5 and 6 are compared with FIGS. 7 and 8, FIGS. 5 and 6 show the release position and/or the coupling position, which is not yet completed, i.e., the plug-in part 3 could be retracted back out of the rotary sleeve of the receiving sleeve 2, whereas FIGS. 7 and 8 show the arrangement after twisting the rotary sleeve 7 in relation to the inserted plug-in part 3, i.e., the axial fixation of the plug-in part 3 in the rotary sleeve 7 of the receiving sleeve 2.

From the comparison of FIGS. 4, 6 and 8, it becomes clear that the outside dimension of the plug-in part 3 in its non-flattened non-round region 3a is larger than the inside dimension of the non-flattened non-round region 7a of the rotary sleeve 7 and thus of the receiving sleeve 2 and the dimensions are selected so that the flattened regions 12 can each be shifted past axially on the non-flattened regions.

The axial extent or dimension of the non-round region 7a of the rotary part 7 of the receiving part 2 is the same as or smaller than the axial width of the undercut or the groove or the ring groove 8 on the plug-in part 3. These dimensional relationships can be seen well in FIG. 7, where the non-round region 7a of the rotary sleeve 7 of the receiving sleeve 2 engages in the ring groove 8 of the plug-in part 3 in a form-fitting manner.

The rotation of the rotary part 7, i.e., the rotary sleeve 7 of the receiving sleeve 2, is limited by a stop 13 on its inside, i.e, the stop 13 on the inside of the rotary sleeve 7 blocks a rotation beyond the coupling position. In FIGS. 9 and 10 in particular this stop can be seen in the form of a radial recess on the inside of the rotary part 7, which has a radial bulge 14 outward at this location at the same time. The rotational path of the rotary part, i.e., the rotary sleeve 7, corresponds approximately to half the circumferential distance between two flattened areas 12 of the plug-in part 3 which are adjacent to one another on the circumference, so it extends over a rotational path of 60°. When there are three flattened areas 12 on the circumference, they are uniformly distributed with an angular distance of 120°.

For the coupling position of the rotary part 7, a protrusion or locking cam 15 is provided on the receiving sleeve 2 engaging in a counter opening forming the stop 13 in the coupling position in the radial direction as shown in FIG. 9. This locking cam 15 of the rotary sleeve and/or the rotary part 7 engages radially in this mating opening forming the stop 13 against a restoring force or spring force, as shown well in FIG. 9. To release the locking position, the locking cam 15 may be adjusted out of this mating opening by pushing it radially inward against this restoring force into a recess 21 arranged in this area. This is done by pushing radially inward the pushbutton 16, which is connected to the locking cam.

A chamfered face 22 on the recess forming the stop 13 allows rotation into the open position without having to depress the pushbutton 16.

It is provided in the exemplary embodiment that, for securing its open position, the rotary sleeve or the rotary part 7 also has a corresponding stop 13 in the form of a groove or a recess or an opening, in which the protrusion or locking cam 15 engages in the open position, as illustrated in FIG. 10. It can be seen that the stop 13, which is provided for the closed position has been rotated clockwise in FIG. 10 by the angle of rotation with respect to the pushbutton 16 and the locking cam 15, by which the rotary sleeve 7 can be rotated between the open position and the closed position.

It is clear here that in this open position, the helical spring 11 is compressed in the circumferential direction, whereas it is loosened in the closed coupling position. The user can thus insert the plug-in part 3 into the rotary sleeve 7 of the receiving sleeve 2 when the sleeve is in the open position and can then depress the pushbutton 16 radially inward, whereby the locking cam 15 leaves the stop 13 in the interior of this rotary sleeve 7 and releases it so that the rotary sleeve is automatically rotated by the force of the spring 11 into the closed position of FIG. 9, where it is locked due to the release of the pushbutton 16.

Especially in FIGS. 4, 6 and 8 it can be seen that the transition from the non-round regions 3a and 7a with the larger radial dimension to the smaller dimension of the flattened areas 12 is designed to be steady and smooth and also rounded so that a large smooth somewhat polygonal circumference is formed on the plug-in part 3 on the one hand and on the inside the rotary sleeve of the receiving part 2 on the other hand.

The support of the rotary sleeve 7 on the receiving part 2 can be seen in the longitudinal cross sections of FIGS. 3, 5 and 7, where a spring ring 17 that prevents an axial adjustment of the rotary sleeve 7 in relation to the receiving sleeve 2 is provided. The spring ring engages both in a ring groove of the receiving part 2 and in an interior ring groove in the rotary sleeve 7.

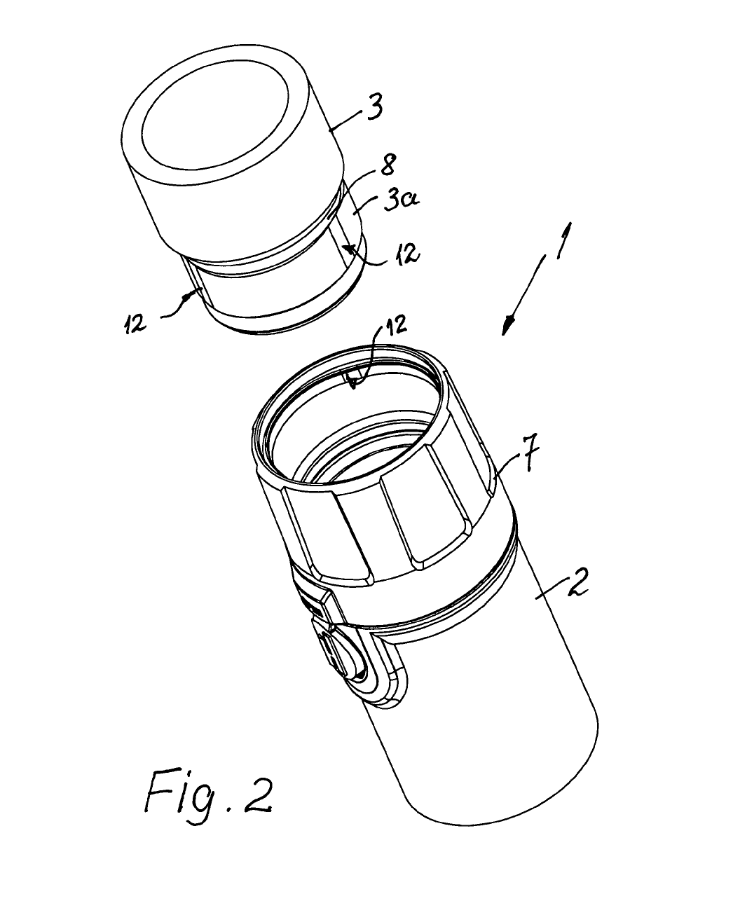

In the exemplary embodiment according to FIGS. 2 to 8, the non-round region 3a of the plug-in part 3 which can be inserted into the rotary sleeve 7 of the receiving part 2 is largely smooth. However, in the exemplary embodiment according to FIG. 1, this region has an outside thread 18 in its non-round region 3a which is partially or completely flattened or removed or sanded down or ground off in the region(s) of smaller outside dimensions, so that this outside thread has the flattened areas 12 provided for the non-round cross section although sections of thread are present between the flattened areas 12. This plug-in part can therefore cooperate with a counter thread or an internal thread of a mating piece, for example, a nut or a housing passage or the like.

At the same time, FIG. 1 also shows an outside thread 19 for a union nut 20 on the receiving sleeve 2 in the end area facing away from its coupling area, said sleeve having in its interior a clamping body for a fixation of a cable leading to the contacts.

The plug-in connector 1 having a receiving sleeve 2 which encloses insulation for contacts 4 and having a plug-in part 3, which also contains insulation 5 for mating contacts 6 and can be plugged together with the former, can be coupled in the plug-in position and secured there without requiring threading with a counter thread or a locking nut. To this end, the outside of the plug 3 and the inside of the rotary sleeve 7 of the receiving sleeve 2 each have a non-round cross section in some regions that can be rotated in relation to the receiving sleeve 2. These non-round cross sections of the plug areas that can be plugged one into the other sit in a form-fitting manner with one another in the circumferential direction and thus allow the parts to be plugged together into their use position. In the use position they are offset axially in relation to one another so that the non-round of the one part engages axially behind that of the other part when the rotary sleeve is rotated into its locked position.

1. A plug-in connector (1) having a receiving sleeve (2) containing axially parallel contacts (4) and having a plug-in part (3) containing insulation (5) for the axially parallel mating contact (6) such that the plug-in part can be assembled with the receiving sleeve, the receiving sleeve (2) and the plug-in part (3) being arranged one inside the other in some areas in the axial direction in the use position and being secured to prevent an axial releasing movement, characterized in that the outside of the plug-in part (3) and the inside of the receiving sleeve (2) have a non-round cross section or circumference in some regions, the non-round cross sections in the circumferential direction sitting one inside the other in a form-fitting manner and being offset axially in relation to one another in the use position, and on the receiving sleeve (2) the non-round region is provided on the inside of a rotary sleeve (7) that can rotate in relation to the receiving sleeve (2), and on the plug-in part (3) an undercut or a groove running over at least a portion of the circumference or a peripheral ring groove (8) is provided in the axial insertion direction behind the non-round cross-sectional region (3a), and the rotary sleeve (7) of the receiving sleeve (2) extends with its non-round inside cross section (7a) in the coupling position into the region of the undercut or the groove or the ring groove (8), and the regions (3a and 7a) having a non-round cross section are adjustable through relative rotation out of their position, in which they fit together in a form-fitting manner into a position in which one engages behind the other.

2. The plug-in connector according to claim 1, characterized in that the non-round region (3a) of the plug-in part (3) can be displaced axially in relation to the non-round region (7a) of the receiving sleeve (2) to the extent that the non-round region (3a) of the plug-in part (3) is situated axially next to the non-round region (7a) of the receiving sleeve (2) and thereby in the area of the undercut (8), so that the relative rotation of the two non-round regions into their self-engaging positions is permitted.

3. The plug-in connector according to claim 1, characterized in that the rotary part of the receiving sleeve (2) is rotatable against a restoring force into the open position and is releasably secured in this position.

4. The plug-in connector according to claim 1, characterized in that between the rotary sleeve (7) of the receiving sleeve (2) and said receiving sleeve (2) is a spring (11) running about a portion of the circumference of said sleeve, said spring being under tension during rotation of the rotary part.

5. The plug-in connector according to claim 1, characterized in that the non-round cross-sectional shape of the non-round region (7a) of the receiving sleeve (2) and the non-round cross-sectional shape of the non-round region (3a) of the plug-in part (3) are formed by at least one flattened area (12) of an originally circular circumference of the coupling regions, in particular by two or three flattened areas (12) offset with respect to one another in the circumferential direction such that the plug-in part (3) and the receiving sleeve (2) can be plugged together axially when the flattened areas (12) of the one part are arranged coaxially with the flattened areas (12) of the neighboring areas.

6. The plug-in connector according to claim 1, characterized in that the parts of the non-round regions (7a) of the receiving sleeve (2) protruding with respect to the flattened areas and the non-round regions (3a) of the plug-in part (3) engage with one another in the axial direction in the coupling position.

7. The plug-in connector according to claim 1, characterized in that the outside dimension of the plug end part (3) in its non-flattened region is greater than the inside dimension of the non-flattened region (7a) of the receiving sleeve (2), and the dimensions are selected so that the flattened regions (12) can each be advanced axially on the non-flattened regions.

8. The plug-in connector according to claim 1, characterized in that the axial extent or dimension of the non-round region (7a) of the rotary part (7) of the receiving sleeve (2) is equal to or smaller than the axial width of the undercut or the groove or the ring groove (8) on the plug-in part (3).

9. The plug-in connector according to claim 1, characterized in that the rotation of the rotary part (7) of the receiving sleeve (2) is limited by an interior stop (13), said stop (13) blocking rotation beyond the coupling position.

10. The plug-in connector according to claim 1, characterized in that the rotational distance of the rotary part (7) corresponds approximately to half the circumferential distance between two flattened areas (12) adjacent to one another on the circumference of the plug-in part (3).

11. The plug-in connector according to claim 1, characterized in that a protrusion or a locking cam (15) is provided for the coupling position of the rotary part (7), said protrusion engaging in a counter opening of the rotary part in the radial direction in the coupling position and in particular being pressed or adjustable radially inward for release.

12. The plug-in connector according to claim 1, characterized in that the rotary part (7) also has a groove or recess for fixation in its open position, in which the protrusion or the locking cam (15) engages in the open position.

13. The plug-in connector according to claim 1, characterized in that the protrusion or locking cam (15) engages in the mating opening of the rotary part (7) to secure the coupling position of the rotary part against a resetting force or spring force, and is adjustable in particularly the radial inward direction for releasing the locking position against this restoring force out of the mating opening.

14. The plug-in connector according to claim 1, characterized in that the transition from the radially larger dimension to the smaller dimension or flattened area (12) in the case of the non-round regions (3a, 7a) is smooth, continuous, or particularly rounded.

15. The plug-in connector according to claim 1, characterized in that the plug-in part has an outside thread (18) in its non-round region, said thread being partially or entirely flattened or removed or sanded down or ground off in the region(s) of the smaller outside dimension.
